(19) United States
(12) Patent Application Publication
(10) Pub. No.: US 2016/0070340 A1
(43) Pub. Date: Mar. 10, 2016

(54) ELECTRONIC DEVICE AND METHOD FOR AUTOMATICALLY ADJUSTING DISPLAY RATIO OF USER INTERFACE

(71) Applicants: Fu Tai Hua Industry (Shenzhen) Co., Ltd, Shenzhen (CN); HON HAI PRECISION INDUSTRY CO., LTD., New Taipei (TW)

(72) Inventors: SHUANG HU, Shenzhen (CN); CHIH-SAN CHIANG, New Taipei (TW); LING-JUAN JIANG, Shenzhen (CN); HUA-DONG CHENG, Shenzhen (CN)

(21) Appl. No.: 14/713,524

(22) Filed: May 15, 2015

(30) Foreign Application Priority Data
Sep. 9, 2014 (CN) 201410459298.2

(51) Int. Cl. G06F 3/01; G06K 9/00; G06T 3/40

(52) U.S. Cl. CPC G06F 3/011; G06T 3/40; G06K 9/00228; G06K 2009/00322

(57) ABSTRACT

An electronic device and a method for automatically adjusting display ratio of user interface are provided. The electronic device includes storage device, a proximity sensor and a touch screen. The method includes the following blocks. The proximity sensor is controlled to measure a distance between the display screen and a user. The distance measured by the proximity sensor is obtained. A display ratio of the user interface is calculated according to the obtained distance and a algorithm which is pre-stored in the storage device. The display ratio of the user interface is adjusted using the calculated display ratio.

### CROSS-REFERENCE TO RELATED APPLICATIONS

This application claims priority to Chinese Patent Application No. 201410459298.2 filed on Sep. 9, 2014, the contents of which are incorporated by reference herein.

### FIELD

The subject matter herein generally relates to user interface adjusting technology, and particularly to an electronic device and a method for automatically adjusting display ratio of a user interface according to distance between the electronic device and a user.

### BACKGROUND

User interface displayed on electronic devices can be zoomed in or out in response to an operation input through input devices. However, it is not convenient to operate the electronic devices when the user is away from the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a system for automatically adjusting display ratio of user interfaces.

FIG. 2 illustrates a flowchart of one embodiment of a method for automatically adjusting display ratio of user interfaces in the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in details so as not to considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media includes CDs, DVDs, BLU-RAY, flash memory, and hard disk drives. The term “comprising” means “including, but not necessarily limited to”; it specifically indicates open-ended inclusion or membership in a so-described combination, group, series and the like.

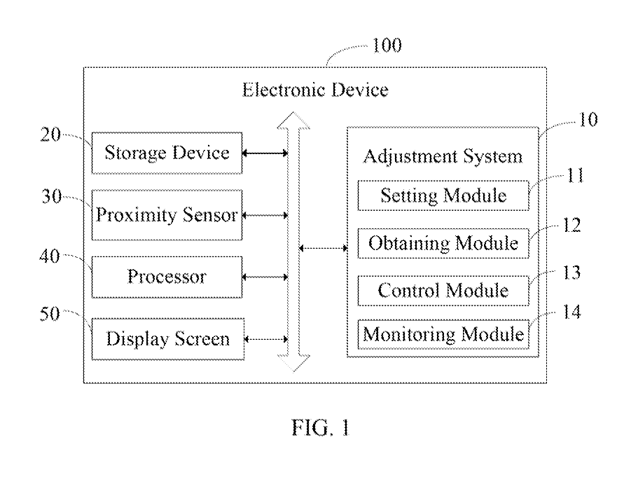

FIG. 1 illustrates a block diagram of one embodiment of an electronic device. In at least one the embodiment as shown in FIG. 1, an electronic device 100 includes, but is not limited to, an adjustment system 10, a storage device 20, a proximity sensor 30, at least one processor 40 and a display screen 50. The electronic device 100 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

The adjustment system 10 can adjust display ratio of a user interface according to a distance between the electronic device 100 and a user.

The storage device 20 can pre-store an algorithm which defines a relationship between display ratios of the user interface and the distance between the display screen 50 and the user, and the storage device 20 can further pre-store a normal display ratio range. In at least one embodiment, the storage device 20 can further store a relation list which defines a relationship between multiple values and multiple age ranges. In at least one embodiment, the farther the distance is, the higher the display ratio of the user interface is; and the closer the distance is, the lower the display ratio of the user interface is. In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium.

The proximity sensor 30 can measure the distance between the display screen and the user.

The at least one processor 40 can be a central processing unit (CPU), a microprocessor, or other data processor chip that performs functions of the adjustment system 10 in the electronic device 100. The display screen 50 can display user interface.

In at least one embodiment, the adjustment system 10 can include a setting module 11, an obtaining module 12, a control module 13 and a monitoring module 14. The function modules 11, 12, 13 and 14 can include computerized codes in the form of one or more programs, which are stored in the storage device 20. The at least one processor 40 executes the computerized codes to provide functions of the function modules 11-14.

The setting module 11 pre-sets the algorithm which defines a relationship between display ratios of user interface and the distance between the display screen 50 and a user. The algorithm includes at least one stationary parameter and other parameters. In the embodiment, the at least one stationary parameter includes an initial distance L₀ and a step display ratio ΔP, the other parameters include a step distance ΔL corresponding to the step display ratio ΔP and an initial display ratio P₀ corresponding to the initial distance L₀.

In the embodiment, assuming “L” represents a real-distance which is measured by the proximity sensor 30, and assuming “P” represents a real-ratio corresponding to the real-distance “L”. In the embodiment, when the real-distance L increases or decreases a step distance ΔL compared to the initial distance L₀, the real-ratio P increases or decreases a step display ratio ΔP relative to the initial display ratio P₀. The algorithm is: P=P₀+[(L−L₀)/ΔL]*ΔP, in at least one embodiment, in order to avoid the real-ratio changes caused by a slight shaking of the electronic device 100, the value of the (L−L₀)/ΔL take integer, that is to say, the value of the [(L−L₀)/ΔL] is a maximum integer which is not greater than the value of the (L−L₀)/ΔL.

The setting module 11 further sets the value of each parameter and a normal display ratio range according to data input by the user to be stored in the storage device 20. In the embodiment, the value of the initial display ratio P₀ is set as 100%, the step distance ΔL is a constant set by the user. In at least one embodiment, the setting module 11 further selects at least one of the multiple values stored in the storage device 20 according to an age range of the user, and assigns the at least one selected value to the at least one stationary parameter of the algorithm. In other words, the value of the initial distance L₀ and the step display ratio ΔP varies by the visual acuity of the user. In the embodiment, the users are divided into three classes, teenagers, adults and the elderly, which correspond to three different age ranges.

For example, for adults assuming the initial distance L₀ is 45 cm, the initial display ratio P₀ is 100%, the value of step distance ΔL is 10 cm, and the value of step display ratio ΔP is 15%. The corresponding relationship between the real-ratio P and the real-distance L as shown in the following table:

| L (cm) | [0, 15) | [15, 25) | [25, 35) | [35, 45) | [45, 55) | [55, 65) | . . . |
|---|---|---|---|---|---|---|---|
| P(%) | 55% | 70% | 85% | 100% | 115% | 130% | . . . |

For teenagers and the elderly, the value of the step display ratio ΔP differs from adults. In the case of equal step distance ΔL, the value of the step display ratio ΔP is: ΔP_{the elderly}>ΔP_{adults}ΔP_{teenagers}. In the embodiment, the value of the step distance ΔL is 10 cm, the value of the step ratio for the elderly ΔP_{the elderly} is 20%, and the value of the step ratio for teenagers is 10%.

The obtaining module 12 obtains identify information of the user and determines which group the user belongs, and obtains, from the storage device 20, the corresponding pre-stored values according to the determined group. In the embodiment, the obtaining module 12 can obtain the age of the user according to registration information, and also can determine the age of the user by facial recognition method and the like, and then obtain, from the storage device 20, the corresponding parameter values according to the age of the user, and then the setting module 12 assigns the obtained values to the stationary parameters. Furthermore, users can set the value of the parameters according to their own habits or special situations.

The control module 13 controls the proximity sensor 30 to measure distance between the display screen 50 and a user;

The obtaining module 12 further obtains the distance measured by the proximity sensor 30.

The control module 13 further calculates a display ratio of the user interface according to the obtained distance and the algorithm.

The monitoring module 14 determines whether the calculated display ratio falls into the normal display ratio range stored in the storage device 20. If the calculated display ratio falls in the normal display ratio range, the control module 13 adjusts the display ratio of the user interface using the calculated display ratio. Otherwise, if the calculated display ratio does not fall in the normal display ratio range, the monitoring module 14 further determines whether the calculated display ratio is greater than a maximum value of the normal display range. If the calculated display ratio is greater than the maximum value, the control module 13 adjusts the display ratio of the user interface using the maximum value of the normal display ratio range; if the calculated display ratio is not greater than the maximum value, the control module 13 adjusts the display ratio of the user interface using a minimum value of the normal display ratio range.

For example, assuming the initial font size of the user interface is 24 px, and the normal display ratio range is 40%-180%. If the calculated display ratio is 75% which falls in the normal display ratio range, the control module 13 displays the user interface by font size of 24 px*75%=18 px. If the calculated display ratio is 30% which does not fall in the normal display ratio range and is not greater than the maximum value of the normal display ratio range, the control module 13 adjusts the display ratio of the user interface by 40%. If the calculated display ratio is 200% which does not fall in the normal display ratio range and greater than the maximum value of the normal display ratio range, the control module 13 adjusts the display ratio of the user interface by 180%.

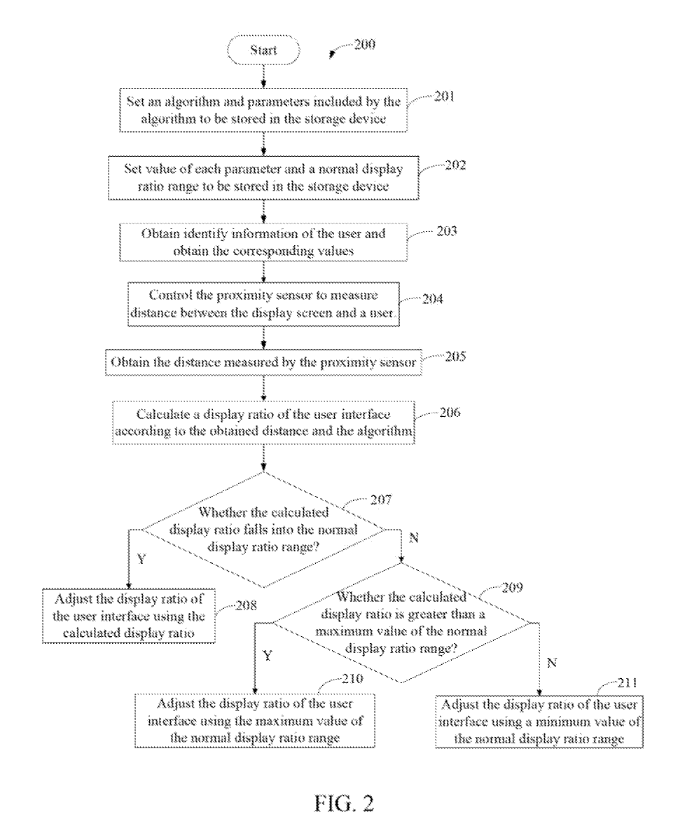

FIG. 2 illustrates a flowchart of one embodiment of a method for automatically adjusting display ratio of user interfaces. The example method 200 is provided by way of example, as there are a variety of ways to carry out the method. The example method 200 described below can be carried out using the configurations illustrated in FIG. 1 for example, and various elements of these figures are referenced in explaining example method 200. Each block shown in FIG. 2 represents one or more processes, methods, or subroutines carried out in the example method 200. Additionally, the illustrated order of blocks is by example only and the order of the blocks can be changed. The example method 200 can begin at block 201. Depending on the embodiment, additional steps can be added, others removed, and the ordering of the steps can be changed.

In block 201, a setting module sets an algorithm which includes multiple parameters, and stores the algorithm in the storage device 20.

In block 202, the setting module sets the value of each parameter and a normal display ratio range according to data input by the user to be stored in the storage device 20.

In block 203, an obtaining module obtains identify information of the user and determines the group which the user belongs, and obtains, the corresponding pre-set parameter values according to the determined group, from the storage device 20 and then the setting module assigns the obtained values to the stationary parameters of the algorithm.

In block 204, a control module controls the proximity sensor 30 to measure distance between the display screen 50 and a user.

In block 205, the obtaining module obtains the distance measured by the proximity sensor 30.

In block 206, the control module calculates a display ratio of the user interface according to the obtained distance and the algorithm.

In block 207, a monitoring module determines whether the calculated display ratio falls into the normal display ratio range stored in the storage device 20. If the calculated display ratio falls in the normal display ratio range, block 207 is implemented. Otherwise, if the calculated display ratio does not fall in the normal display ratio range, block 208 is implemented.

In block 208, the control module adjusts the display ratio of the user interface using the calculated display ratio.

In block 209, the monitoring module determines whether the calculated display ratio is greater than a maximum value of the normal display range. If the calculated display ratio is greater than the maximum value, block 209 is implemented. Otherwise, if the calculated display ratio is not greater than the maximum value, block 210 is implemented.

In block 210, the control module adjusts the display ratio of the user interface using the maximum value of the normal display ratio range.

In block 211, the control module adjusts the display ratio of the user interface using a minimum value of the normal display ratio range.

With such a configuration, the display ratio of the user interface can be adjusted automatically according to the distance between the electronic device 100 and the user.

It should be emphasized that above-described embodiment of the present disclosure, including any particular embodiments are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a display screen;
at least one processor coupled to the display screen;
a proximity sensor coupled to the at least one processor; and
a non-transitory storage device storing an algorithm which defines a relationship between display ratios of the user interface and the distance between the display screen and a user; and
the storage device further storing one or more programs which, when executed by the at least one processor, cause the at least one processor to:
control the proximity sensor to measure distance between the display screen and the user;
obtain the distance measured by the proximity sensor;
calculate a display ratio of the user interface according to the obtained distance and the algorithm; and
adjust the display ratio of the user interface using the calculated display ratio.

2. The electronic device according to claim 1, wherein the storage device is further configured to pre-store a normal display ratio range, and the at least one processor further:
determines whether the calculated display ratio falls into the normal display ratio range;
if the calculated display ratio does not fall in the normal display ratio range, determines whether the calculated display ratio is greater than a maximum value of the normal display ratio range; and
if the calculated display ratio is greater than the maximum value, adjusts the display ratio of the user interface using the maximum value of the normal display ratio range.

3. The electronic device according to claim 2, wherein if the calculated display ratio is not greater than the maximum value, the at least one processor further adjusts the display ratio of the user interface using a minimum value of the normal display ratio range.

4. The electronic device according to claim 1, wherein the storage device further stores a relation list which defines a relationship between multiple values and multiple age ranges, wherein the algorithm comprises at least one stationary parameter, the at least one processor further selects at least one of the multiple values stored in the storage device according to an age range of the user, and assigns the at least one selected value to the at least one stationary parameter of the algorithm.

5. A method for automatically adjusting display ratio of user interface, applied in an electronic device with a display screen and a proximity sensor, the method comprising:
controlling the proximity sensor to measure distance between the display screen and a user;
obtaining the distance measured by the proximity sensor;
calculating a display ratio of the user interface according to the obtained distance and an algorithm stored in a storage device of the electronic device, wherein the algorithm defines a relationship between display ratios of the user interface and the distance between the display screen and the user; and
adjusting the display ratio of the user interface using the calculated display ratio.

6. The method according to claim 5, further comprising:
determining whether the calculated display ratio falls into a normal display ratio range which is pre-stored in the storage device;
upon determining that the calculated display ratio does not fall in the normal display ratio range, determining whether the calculated display ratio is greater than a maximum value of the normal display ratio range;
upon determining that the calculated display ratio is greater than the maximum value, adjusting the display ratio of the user interface using the maximum value of the normal display ratio range.

7. The method according to claim 6, further comprising:
upon determining that the calculated display ratio is not greater than the maximum value, adjusting the display ratio of the user interface using a minimum value of the normal display ratio range.

8. The method according to claim 5, wherein the storage device further stores a relation list which defines a relationship between multiple values and multiple age ranges, wherein the algorithm comprises at least one stationary parameter, the method further comprising:
selecting at least one of the multiple values stored in the storage device according to an age range of the user, and assigning the at least one selected value to the at least one stationary parameter of the algorithm.

9. A non-transitory storage medium having stored thereon instructions that, when executed by a processor of an electronic device, causes the processor to perform a method for automatically adjusting display ratio of user interface, the electronic device further comprises a display screen and a proximity sensor, wherein the method comprising:
controlling the proximity sensor to measure distance between the display screen and a user;
obtaining the distance measured by the proximity sensor;
calculating a display ratio of the user interface according to the obtained distance and an algorithm stored in a storage device of the electronic device, wherein the algorithm defines a relationship between display ratios of the user interface and the distance between the display screen and the user; and
adjusting the display ratio of the user interface using the calculated display ratio.

10. The non-transitory storage medium according to claim 9, wherein the method further comprising:
determining whether the calculated display ratio falls into a normal display ratio range which is pre-stored in the storage device;
upon determining that the calculated display ratio does not fall in the normal display ratio range, determining whether the calculated display ratio is greater than a maximum value of the normal display ratio range;
upon determining that the calculated display ratio is greater than the maximum value, adjusting the display ratio of the user interface using the maximum value of the normal display ratio range.

11. The non-transitory storage medium according to claim 10, wherein the method further comprising:
upon determining that the calculated display ratio is not greater than the maximum value, adjusting the display ratio of the user interface using a minimum value of the normal display ratio range.

12. The non-transitory storage medium according to claim 9, wherein the storage device further stores a relation list which defines a relationship between multiple values and multiple age ranges, wherein the algorithm comprises at least one stationary parameter, the method further comprising:
selecting at least one of the multiple values stored in the storage device according to an age range of the user, and assigning the at least one selected value to the at least one stationary parameter of the algorithm.
